(19) United States
(12) Patent Application Publication
(10) Pub. No.: US 2026/0285266 A1
(43) Pub. Date: Sep. 24, 2026

(54) BRAKE SYSTEM AND CONTROL METHOD THEREOF

(71) Applicant: HL MANDO CORPORATION, Gyeonggi-do (KR)

(72) Inventors: Sihun LEE, Gyeonggi-do (KR); Jaehoon JANG, Gyeonggi-do (KR); Yongkil KIM, Gyeonggi-do (KR)

(21) Appl. No.: 19/318,350

(22) Filed: Sep. 3, 2025

(30) Foreign Application Priority Data
Mar. 20, 2025 (KR) 10-2025-0036124

(51) Int. Cl. B60T 8/172; B60T 8/171; B60T 8/1761; B60T 8/58; B60T 13/74; H02P 3/04

(52) U.S. Cl. CPC B60T 8/172; B60T 8/171; B60T 8/17616; B60T 8/58; B60T 13/746; H02P 3/04; B60T 2220/04; B60T 2240/02

(57) ABSTRACT

A brake system includes an electro mechanical brake including a motor and configured to brake a wheel of a vehicle using the motor and an electro mechanical brake controller configured to control the motor, in which the electro mechanical brake controller is configured to determine a target speed for controlling the motor based on a target braking pressure, wherein the target speed for controlling the motor changes in proportion to a rate of change of the target braking pressure, control the motor based on the target speed for controlling the motor, feedback-control the motor based on a current speed of the motor and the target speed for controlling the motor, and control the motor to generate a torque of the motor determined by adding a first torque of the motor controlled based on the target speed for controlling the motor and a second torque of the motor feedback-controlled based on the current speed of the motor and the target speed for controlling the motor.

### CROSS-REFERENCE TO RELATED APPLICATIONS

This application claims the priority of Korean Patent Application No. 10-2025-0036124 filed on Mar. 20, 2025, in the Korean Intellectual Property Office, the disclosure of which is incorporated herein by reference.

### BACKGROUND

### Field

The present disclosure relates to a brake system and a control method thereof.

### Description of the Related Art

When a conventional integrated dynamic brake (IDB) system controls the supply of hydraulic pressure to a wheel cylinder of each wheel at a high target pressure value, the speed is slowed down by a device that acts as a damper, that is, a damping element, until the target pressure value is reached. For example, the integrated dynamic brake system supplies hydraulic pressure to the wheel cylinder of each wheel according to the pressure of a brake pedal, and, in the process of applying pressure to a piston when a valve expands, the speed is slowed down by a device that acts as a mechanical damper, such as a rubber hose, until the high target pressure value is reached.

Meanwhile, an electro mechanical brake (EMB) operates in the process of converting a primary braking intention of a user into actual braking force according to the occurrence of the primary braking intention of the user. However, when the electro mechanical brake performs pressure-boosting when operating together with an anti-lock braking system (ABS) in an emergency braking situation, the speed of the motor may be set too high. In this case, a brake pad may excessively contact a disc according to the set motor speed, which may cause shock and wheel slip, resulting in loss of braking force. In other words, when the electro mechanical brake cannot stop the motor because the motor speed is too fast in a situation where it must control the generated motor speed, unnecessary braking force is generated, which may cause the anti-lock braking system to not be properly controlled during the braking cycle.

When the motor of the electro mechanical brake is initially driven, it is difficult to properly implement desired pressure-boosting performance because the target pressure value cannot be quickly followed due to a torque ripple component that occurs in a pressure-boosting direction and a mechanical frictional force. As a result, when controlling the anti-lock braking system, it is necessary to secure braking force by rapid pressure-boosting, but it is difficult to secure the desired amount of braking force in an initial section during the braking cycle. In addition, when the non-response or low-response time becomes long when the pressure is boosted for each section during the braking cycle of the anti-lock braking system, the vehicle braking is not properly performed during the corresponding section, so the vehicle travels in the direction in which the vehicle is moved previously, which causes shaking to worsen and there has been a problem that the braking feel is worse.

### SUMMARY

One aspect of the present disclosure may provide a brake system and a control method thereof capable of quickly following a target pressure-boosting amount of a higher controller while improving pressure-boosting response when an electro mechanical brake operates together with an anti-lock braking system (ABS) in an emergency braking situation.

Therefore, according to the brake system and the control method, it is possible to improve the braking feel corresponding to the yaw and pitch shaking of the vehicle by quickly decelerating the motor in a section where a target pressure-boosting value is maintained while securing the braking force, thereby securing a short braking cycle period.

In addition, according to the brake system and the control method thereof, it is possible to improve the responsiveness so that the target pressure-boosting amount of the higher controller can be quickly followed, thereby eliminating the conventional logic added to supplement the responsiveness of the electro mechanical brake and adjusting the performance based on the logic of the vehicle to which the actual integrated dynamic brake system is applied. Then, when the brake system and the control method thereof configure the finely adjustable logic, which is a feature of a permanent magnet synchronous motor (PMSM), it may lead to additional improvement in the braking performance of the vehicle.

According to one aspect of the present disclosure, there is provided brake system including: an electro mechanical brake including a motor and configured to brake a wheel of a vehicle using the motor; and an electro mechanical brake controller configured to control the motor, in which the electro mechanical brake controller is configured to determine a target speed for controlling the motor based on a target braking pressure, wherein the target speed for controlling the motor changes in proportion to a rate of change of the target braking pressure, control the motor based on the target speed for controlling the motor, feedback-control the motor based on a current speed of the motor and the target speed for controlling the motor, and control the motor to generate a torque of the motor determined by adding a first torque of the motor controlled based on the target speed for controlling the motor and a second torque of the motor feedback-controlled based on the current speed of the motor and the target speed for controlling the motor.

The electro mechanical brake controller may apply the second torque feedback-controlled based on the current speed of the motor and the target speed for controlling the motor, to the motor at an initial rise point of the target braking pressure.

The electro mechanical brake controller may reduce the second torque applied to the motor while maintaining the target braking pressure within a predetermined minimum range.

The electro mechanical brake controller may apply the second torque applied to the motor at an initial reduction point of the target braking pressure.

The brake system may further include a controller that performs an anti-lock braking control in response to slip of the wheel of the vehicle and determines the target braking pressure based on anti-lock braking control to transmit the determined target braking pressure to the electro mechanical brake controller.

The electro mechanical brake controller may determine the target speed for controlling the motor based on a difference between the target braking pressure and a current braking pressure of the electro mechanical brake.

The electro mechanical brake controller may determine the target speed for controlling the motor by multiplying a difference between the target braking pressure and a current braking pressure of the electro mechanical brake by a predetermined gain value.

The electro mechanical brake controller may determine the target speed for controlling the motor corresponding the difference between the target braking pressure and the current braking pressure of the electro mechanical brake using predetermined mapping of a plurality of target speeds to a plurality of differences.

The electro mechanical brake controller may control a speed of the motor not to exceed a predetermined maximum speed.

The electro mechanical brake controller may feedback-control the motor so that the current speed of the motor follows the target speed for controlling the motor through proportional integral derivative (PID) control.

According to one aspect of the present disclosure, there is provided method for controlling of a brake system including: determining a target speed for controlling a motor of an electro mechanical brake based on a target braking pressure,, the target speed for controlling the motor changes in proportion to a rate of change of the target braking pressure; controlling the motor based on the target speed for controlling the motor; feedback-controlling the motor based on a current speed of the motor and the target speed for controlling the motor; and controlling the motor to generate a torque of the motor determined by adding a first torque of the motor controlled based on the target speed for controlling the motor and a second torque of the motor feedback-controlled based on the current speed of the motor and the target speed for controlling the motor.

The second torque feedback-controlled based on the current speed of the motor and the target speed for controlling the motor may be applied to the motor at an initial rise point of the target braking pressure.

The second torque applied to the motor may be reduced while the target braking pressure is maintained within a predetermined minimum range.

The second torque applied to the motor may be applied at an initial reduction point of the target braking pressure.

The target braking pressure may be determined based on anti-lock braking control in response to slip of the wheel of the vehicle.

The determining of the target speed for controlling the motor may include determining the target speed for controlling the motor based on a difference between the target braking pressure and a current braking pressure of the electro mechanical brake.

The determining of the target speed for controlling the motor may include determining the target speed for controlling the motor by multiplying a difference between the target braking pressure and a current braking pressure of the electro mechanical brake by a predetermined gain value.

The determining of the target speed for controlling the motor may include determining the target speed for controlling the motor corresponding the difference between the target braking pressure and the current braking pressure of the electro mechanical brake using predetermined mapping of a plurality of target speeds to a plurality of differences.

The method of the brake system may further include controlling a speed of the motor not to exceed a predetermined maximum speed.

The feedback-controlling of the motor may include feedback-controlling the motor so that the current speed of the motor follows the target speed for controlling the motor through proportional integral derivative (PID) control.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a vehicle including a brake system according to one embodiment;

FIG. 2 is a diagram for explaining control of an electro mechanical brake of the brake system according to one embodiment;

FIG. 3 is a flowchart of the operation of the electro mechanical brake controller of the brake system according to one embodiment;

FIG. 4 is a flowchart of the operation of the brake system according to one embodiment;

FIGS. 5A and 5B are graphs illustrating a relationship between a target speed, a motor position, and a wheel speed when an anti-lock braking system mode of the brake system according to one embodiment is executed; and

FIGS. 6A and 6B are graphs illustrating an actual pressure of an electro mechanical brake and a position of a motor of the electro mechanical brake according to a target braking pressure in a state of conventional pressure-boosting and pressure-reducing performance not improved and a state of pressure-boosting and pressure-reducing performance improved according to the above-described embodiment in the execution of the anti-lock braking system mode.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals refer to like elements throughout the specification. The present specification does not describe all elements of the embodiments, and any content that is general in the technical field to which the present disclosure belongs or that overlaps between the embodiments is omitted. The terms “portion, module, element, or block” used in the specification may be implemented in software or hardware, and according to the embodiments, a plurality of “portions, modules, elements, or blocks” may be implemented as a single element, or a single “portion, module, element, or block” can include a plurality of elements.

Throughout the specification, when a part is said to be “connected” to another part, this includes not only direct connection but also indirect connection, and indirect connection includes connection via a wireless communications network.

Additionally, when a part is said to “include” a component, this does not mean that it excludes other components, unless otherwise specifically stated, but rather that it may include other components.

Throughout the specification, when it is said that an element is located “on” another element, this includes not only cases where an element is in contact with another element, but also cases where another element exists between the two elements.

The terms first, second, and the like are used to distinguish one component from another, and the components are not limited by the aforementioned terms.

Singular expressions include plural expressions unless the context clearly indicates otherwise.

The identification codes in each step are used for convenience of explanation and do not describe the order of each step. Each step may be performed in a different order than specified unless the context clearly indicates a specific order.

A reference torque applied to a motor of an electro mechanical brake may be generated according to a pressure-boosting request amount (unit: N) of a brake control unit (BCU), and reference currents of Q-axis and D-axis currents in a synchronous reference frame may be calculated by feed forward control. Thereafter, a torque required to drive the motor may be generated based on the reference current.

When the motor is in feed forward control, the motor position may increase steadily, and accordingly, the pressure-boosting amount may also increase steadily.

When an operating mode of the vehicle is switched to the anti-lock braking system operating mode, the electro mechanical brake motor operates at high speed, and at the moment when a rapid mode switch is required, energy loss, heat generation, reduced efficiency, noise, and/or vibration may become problems due to increased counter electromotive force, increased iron loss, and/or aggravated magnetic flux ripple.

Due to the influence of such problems, distortion may occur when calculating the reference current of the Q-axis and D-axis currents, and other noises may become prominent in a control speed range of the motor.

In addition, when the pressure-boosting request amount of the brake control unit is a small value, the reference torque is set to a small value and the motor should move slightly, but the motor responsiveness of the electro mechanical brake may decrease due to various environmental variables, which may hinder the pressure-boosting performance of the electro mechanical brake.

In order to solve such a problem, an embodiment of the present disclosure sets the target speed of the motor as the reference speed, and tunes the reference speed by a gain (or gain value) to suit the vehicle so that the pressure boost of the electro mechanical brake may be increased as much as desired.

More specifically, the embodiment of the present disclosure provides a technology for improving the pressure-boosting performance so that the motor of the electro mechanical brake may operate quickly and stably at a time when the fast responsiveness of the motor of the electro mechanical brake must be secured, for example, at the time of operation of the anti-lock braking system mode.

Hereinafter, the operating principle and embodiments of the present disclosure will be described with reference to the attached drawings.

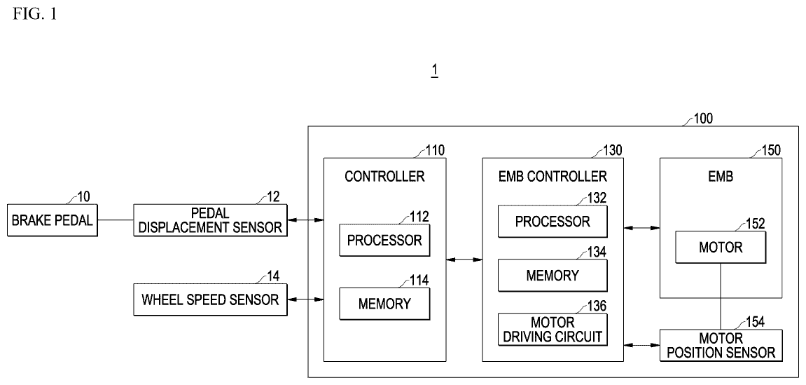

FIG. 1 is a block diagram of a vehicle including a brake system according to one embodiment.

Referring to FIG. 1, a vehicle 1 may include a brake pedal 10, a pedal displacement sensor 12, a wheel speed sensor 14, and/or a brake system 100.

The brake pedal 10 may obtain a driver's input for braking operation of the vehicle 1.

For example, the brake pedal 10 may be provided at a lower portion of cabin so that the driver can control the brake pedal with his/her foot. The driver may step on the brake pedal 10 as an intention to brake the vehicle 1, and accordingly, the brake pedal 10 may move away from a reference position.

The pedal displacement sensor 12 may detect (or obtain displacement information) the displacement of the brake pedal 10.

For example, the pedal displacement sensor 12 may be physically connected to the brake pedal 10 and measure the movement of the brake pedal 10. The pedal displacement sensor 12 may detect a movement distance and/or movement speed from a reference position of the brake pedal 10.

The pedal displacement sensor 12 may be electrically connected and/or communicatively connected to the brake system 100 and may provide a signal to the brake system 100.

For example, the pedal displacement sensor 12 may be directly connected to the brake system 100 via a hard wire and/or connected to the brake system 100 via a communications network.

The pedal displacement sensor 12 may provide an electrical signal corresponding to the movement distance and/or movement speed of the brake pedal 10 to the brake system 100.

The pedal displacement sensor 12 may be provided integrally with the brake system 100.

The wheel speed sensor 14 may detect the speed of the wheel (or also called a rotation speed of the wheels) of the vehicle 1. The wheel speed sensor 14 may include a plurality of wheel speed sensors each installed on the wheels of the vehicle 1. Each of the plurality of wheel speed sensors may independently detect the speed of the corresponding wheel.

The wheel speed sensor 14 may be electrically connected to the brake system 100 and provide an electrical signal to the brake system 100.

For example, each of the plurality of wheel speed sensors may be directly connected to the brake system 100 via a hard wire and/or connected to the brake system 100 via a communication network. Each of the plurality of wheel speed sensors may provide an electrical signal corresponding to the rotation speed of the corresponding wheel to the brake system 100.

The brake system 100 may include a controller 110, an electro mechanical brake (EMB) controller 130 and/or an electro mechanical brake 150.

The controller 110 may receive the output signal of the pedal displacement sensor 12 and/or the wheel speed sensor 14, and identify occurrence of wheel slip of the vehicle 1 based on the output signal of the pedal displacement sensor 12 and/or the wheel speed sensor 14.

The controller 110 may execute the anti-lock braking system mode based on the occurrence of wheel slip of the vehicle 1.

The controller 110 may execute the anti-lock braking system mode based on the output signal of the pedal displacement sensor 12 and/or the wheel speed sensor 14 when the vehicle is traveling on a high-friction road.

For example, the controller 110 may generate a target braking pressure based on the output signal of the pedal displacement sensor 12 and/or the wheel speed sensor 14 according to the execution of the anti-lock braking system mode, and provide a control signal including the target braking pressure to the electro mechanical brake controller 130.

The controller 110 may be referred to as a brake control unit (BCU) and may include an electronic control unit (ECU).

The controller 110 may include a processor 112 and/or memory 114.

The processor 112 may process the output signal of the pedal displacement sensor 12 and/or the wheel speed sensor 14, and based on the output signal, may switch the operating mode of the vehicle 1 to an anti-lock braking system operating mode to reduce wheel slip of the vehicle 1, and determine a target braking pressure.

The processor 112 may generate the control signal including the target braking pressure and provide the control signal to the electro mechanical brake controller 130.

The processor 112 may provide brake application (Apply) and brake release (Release) signals in the form of force (unit: N) to the electro mechanical brake controller 130 while maintaining an appropriate wheel slip amount of the vehicle 1 in the anti-lock braking system operating mode.

The memory 114 may store or remember programs and data for implementing operations to control the components included in the brake system 100 by the processor 112.

The memory 114 provides stored programs and data to the processor 112 and may remember temporary data generated during the operation of the processor 112.

For example, the memory 110 may include volatile memory such as static random access memory (S-RAM) and dynamic random access memory (D-RAM), and nonvolatile memory such as read only memory (ROM), erasable programmable read only memory (EPROM), electrically erasable programmable read only memory (EEPROM), and flash memory.

The electro mechanical brake controller 130 may receive the target braking pressure (or also called target pressure force) of the electro mechanical brake 150 from the controller 110 and drive the motor 152 of the electro mechanical brake 150 based on the target braking pressure. For example, the electro mechanical brake controller 130 may apply a pulse width modulation (PWM) voltage for driving the motor to a motor driving circuit 136 to provide current to the motor 152.

The electro mechanical brake controller 130 may control the motor 152 to generate or reduce braking force to the vehicle 1, that is, to apply braking force to each wheel of the vehicle 1, based on receiving a signal for braking control or braking release of the vehicle 1 from the controller 110.

The electro mechanical brake controller 130 may determine the target speed of the motor 152 based on the target braking pressure, and determine the target speed as the reference speed of the motor 152. For example, the electro mechanical brake controller 130 may determine the reference speed so as to change in proportion to a rate of change of the target braking pressure.

The electro mechanical brake controller 130 may determine the target speed of the motor based on a difference value between the target braking pressure and a current braking pressure of the electro mechanical brake controller 130.

For example, the electro mechanical brake controller 130 may determine the target speed by multiplying the difference value between the target braking pressure and the current braking pressure of the electro mechanical brake controller 130 by a predetermined gain value. Alternatively, a target speed mapped to each of the difference values between a target braking pressure and a current braking pressure of the electro mechanical brake controller 130 may be predetermined and stored. Accordingly, the electro mechanical brake controller 130 may determine the target speed as a predetermined value mapped to the difference between the target braking pressure and the current braking pressure of the electro mechanical brake controller 130.

The electro mechanical brake controller 130 may feed forward control the motor 152 based on the reference speed.

The electro mechanical brake controller 130 may feedback control the motor 152 based on the current speed and reference speed of the motor 152.

The current speed of the motor 152 may be determined by obtaining speed information provided by an inverter that controls the speed of the motor 152, a technology for estimating the speed based on the cycle of a pulse width modulation (PWM) signal and changes in voltage and current, or a technology for tracking the speed of the motor 152 based on current and voltage applied to the conventional motor 152. Alternatively, the current speed of the motor 152 may be determined based on an output signal of an encoder that measures a rotation angle of a motor shaft to calculate the rotation speed, or a Hall sensor that detects changes in a magnetic field generated through a magnet attached to the rotation shaft of the motor 152.

The electro mechanical brake controller 130 may control the motor 152 to generate the determined torque by determining the torque of the motor 152 as the sum of a feed forward torque (also called a first torque) of the motor 152 based on the feed forward control and a feedback torque (also called a second torque) of the motor 152 based on the feedback control.

The reference speed, which changes in proportion to the rate of change of the target braking pressure, may be maximum at an initial pressure-boosting point when the target braking pressure increases and at an initial pressure-reduction point when the target braking pressure decreases. Accordingly, additional feedback torque applied to the motor 152 of the electro mechanical brake 150 may be applied at the initial response.

Additionally, when the reference speed becomes 0 while the target braking pressure is maintained, the electro mechanical brake controller 130 may identify the reference speed, recover the feedback torque, that is, reduce the feedback torque, and decelerate the speed of the motor 152.

Accordingly, the motor 152 of the electro mechanical brake 150 may be made to respond quickly and stably to the target braking pressure.

The electro mechanical brake controller 130 may include a processor 132, memory 134 and/or motor driving circuit 136.

The processor 132 may convert the target braking pressure of the electro mechanical brake 150 into torque of the motor 152 of the electro mechanical brake 150 and generate a signal for controlling the motor 152.

The memory 134 may store or remember programs and data for implementing operations to control the components included in the electro mechanical brake controller 130 by the processor 132.

The motor driving circuit 136 may drive the motor 152 based on the control signal of the processor 132. For example, the motor driving circuit 136 may receive a PWM signal from the processor 132 and adjust the current of the motor 152. Depending on the adjustment of the current of the motor 152, the speed and torque of the motor 152 may be adjusted.

For example, the motor driving circuit 136 may include a three-phase inverter including a plurality of switching elements that controls a driving current supplied to the motor 152, and an inverter driver that controls the switching elements included in the three-phase inverter according to a motor control signal of the processor 132.

The inverter driver may provide a motor drive signal for driving the three-phase inverter to the switching elements of the three-phase inverter according to the motor control signal of the processor 132.

The three-phase inverter may convert direct current power supplied from the battery of the vehicle 1 into alternating current power according to a motor driving signal of the inverter driver, and may provide the converted alternating current power to the motor 152.

The motor 152 may generate rotational force by receiving driving current from the motor driving circuit 136.

For example, the motor 152 may be a DC motor or a three-phase motor (for example, a brushless DC motor (BLDC), a brushless AC motor (BLAC), or a permanent magnet synchronous motor (PMSM)).

The electro mechanical brake 150 includes the motor 152 and may generate the braking force by moving a piston according to the driving of the motor 152. For example, the electro mechanical brake 150 may be a caliper brake or a drum brake.

The caliper brake may include a pair of pad plates installed to pressurize a brake disc that rotates together with a corresponding wheel, a caliper housing that operates the pair of pad plates, a piston installed retractably inside the caliper housing, a power conversion unit that receives a rotational driving force for moving the piston, converts the rotational driving force into a linear driving force, and transmits the linear driving force to the piston, and/or a brake motor (for example, motor 152) that generates a rotational driving force for moving the piston.

The drum brake includes a pair of brake shoes having an arcuate shape and movably installed along a surface of a backing plate coupled to a vehicle body, a drum having a friction surface on an inner periphery thereof and rotating together with a corresponding wheel of the vehicle, and/or an electric actuator that applies force to each brake shoe in a direction extending the pair of brake shoes, and the electric actuator may include a motor (for example, motor 152), a reducer, and/or a pressurizing mechanism.

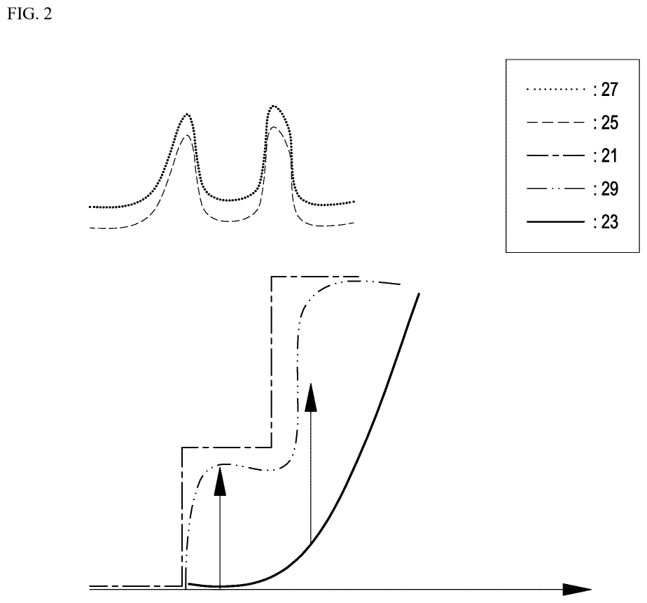

FIG. 2 is a diagram for explaining control of the electro mechanical brake of the brake system according to one embodiment.

Referring to FIG. 2, in a state where the motor 152 of the electro mechanical brake 150 has not improved the pressure-boosting performance, that is, in a state where the motor has not been tuned, it can be seen that when the target braking pressure 21 of the electro mechanical brake 150 is increased at regular intervals of time and the electro mechanical brake 150 operates, the position 23 of the motor 152 changes in a form in which the slope increases with time. That is, it can be seen that the speed of the motor 152 increases over time.

In order to improve the boosting performance of the motor 152 of the electro mechanical brake 150 according to an embodiment of the present disclosure, that is, to change a current speed 25 of the motor 152 of the electro mechanical brake 150 to match the speed reference 27 of the motor 152 corresponding to the target braking pressure 21, as illustrated in FIG. 2, a position 29 of the motor 152 may be similarly changed to correspond to a target force 21.

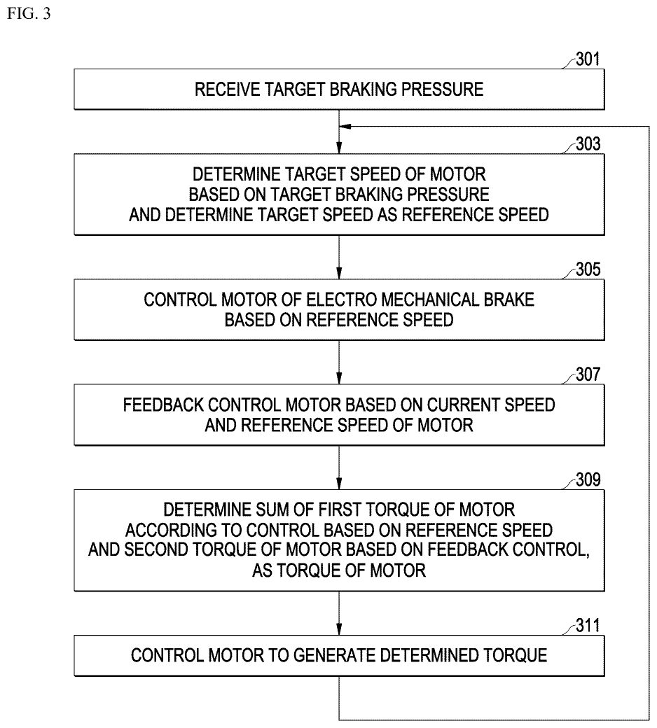

FIG. 3 is a flowchart of the operation of the electro mechanical brake controller 130 of the brake system 100 according to one embodiment.

The electro mechanical brake controller 130 may receive target braking pressure from the controller 110 (301).

The electro mechanical brake controller 130 may determine the target speed of the motor 152 of the electro mechanical brake 150 based on the target braking pressure and determine the target speed as the reference speed (303).

The target speed of the motor 152 means an ideal speed for the electro mechanical brake 150 to reach the target braking pressure. The reference speed of the motor 152 means the speed that the motor 152 of the actual electro mechanical brake 150 should follow, and the control signal for controlling the motor 152 may be determined based on the reference speed.

The electro mechanical brake controller 130 may determine the target speed of the motor 152 based on the difference value between the target braking pressure and the current braking pressure of the electro mechanical brake 150, and determine the determined target speed as the reference speed.

The rate of change of the reference speed may be proportional to the magnitude of the rate of change of the target braking pressure. For example, the larger the rate of change of the target braking pressure, the larger the rate of change of the reference speed may be, and the smaller the rate of change of the target braking pressure, the smaller the rate of change of the reference speed may be.

The electro mechanical brake controller 130 may control the motor 152 of the electro mechanical brake 150 based on the reference speed (305).

Determination of the reference speed and control of the motor 152 based on the reference speed may be called feed forward control.

The electro mechanical brake controller 130 may feedback control the motor 152 based on the current speed and reference speed of the motor 152 (307).

The electro mechanical brake controller 130 may feedback control the motor 152 so that the current speed of the motor 152 follows the reference speed through one of various conventional feed forward control algorithms, for example, a proportional integral derivative (PID) control algorithm.

The electro mechanical brake controller 130 may determine the sum of the first torque of the motor 152 according to the control based on the reference speed and the second torque of the motor 152 based on the feedback control, as the torque of the motor 152 (309).

The electro mechanical brake controller 130 may control the motor 152 to generate the determined torque (311).

For example, an electro mechanical brake controller 130 may regulate the current of the motor 152 to generate the determined torque.

For example, when controlling the motor 152, the electro mechanical brake controller 130 may control the speed of the motor 152 so that the speed does not exceed a predetermined maximum speed. Accordingly, it is possible to prevent the speed of the motor 152 from increasing too quickly, which may cause a load on the electro mechanical brake 150 or cause the motor 152 to overheat.

The electro mechanical brake controller 130 may perform the above-described operation 303 again after controlling the motor 152 to generate the determined torque.

Meanwhile, according to the embodiment of FIG. 3 described above, by determining the target speed according to the target braking pressure as the reference speed, the response speed of the braking pressure increase of the electro mechanical brake 150 may be accelerated as much as desired when the target speed (also called the reference speed) is gain-tuned.

In addition, since the rate of change of the reference speed is proportional to the magnitude of the rate of change of the target braking pressure, the reference speed may be maximum at the pressure-boosting point when the target braking pressure increases, and accordingly, the second torque, which is the feedback torque applied to the motor 152 of the electro mechanical brake 150, may be applied at the initial response. In addition, since the reference speed will be 0 while the target braking pressure is maintained at a constant value, the feedback torque may be recovered and the speed of the motor 152 may be reduced to quickly but stably respond to the target braking pressure.

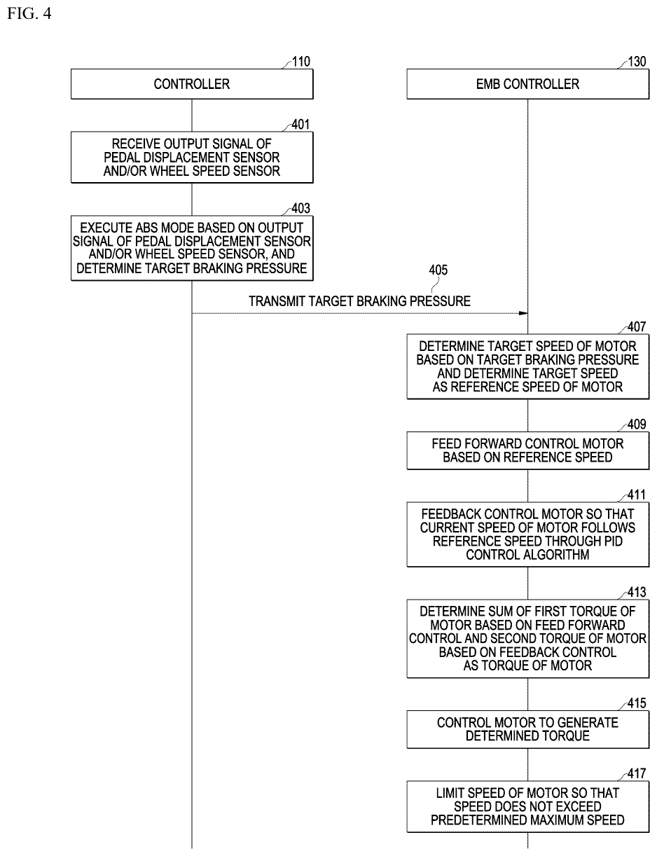

FIG. 4 is a flowchart of the operation of the brake system 100 according to one embodiment.

Referring to FIG. 4, the controller 110 of the brake system 100 may receive the output signal of the pedal displacement sensor 12 and/or the wheel speed sensor 14 (401).

The controller 110 may execute the anti-lock braking system mode based on the output signal of the pedal displacement sensor 12 and/or the wheel speed sensor 14, and determine the target braking pressure through execution of the anti-lock braking system mode (403).

The execution of the anti-lock braking system mode and determination of the target braking pressure based on the output signal of the pedal displacement sensor 12 and/or the wheel speed sensor 14 are conventional techniques and a detailed description thereof will be omitted.

The controller 110 may transmit the target braking pressure to the electro mechanical brake controller 130 (405).

The electro mechanical brake controller 130 may determine the target speed of the motor 152 based on the target braking pressure and determine the target speed as the reference speed of the motor 152 (407).

The rate of change of the reference speed may be proportional to the magnitude of the rate of change of the target braking pressure.

The electro mechanical brake controller 130 may feed forward control the motor 152 based on the reference speed of the motor 152 (409).

For example, the electro mechanical brake controller 130 may control the current of the motor 152 to generate the required torque so that the motor 152 can be driven at the reference speed, and the speed of the motor 152 may be controlled accordingly.

The electro mechanical brake controller 130 may feedback control the motor 152 so that the current speed of the motor 152 follows the reference speed through the PID control algorithm (411).

The PID control algorithm is a feedback control algorithm that adjusts a control signal so that the output maintains a reference value based on an error between a control variable and a reference input. Accordingly, the electro mechanical brake controller 130 calculates a compensation speed through the PID control algorithm, that is, by applying proportional, integral, and differential elements based on the difference between the current speed and the reference speed, and thereby adjusts the speed of the motor 152.

The electro mechanical brake controller 130 may determine the sum of the first torque of the motor 152 based on feed forward control and the second torque of the motor 152 based on feedback control as the torque of the motor 152 (413).

The electro mechanical brake controller 130 may control the motor 152 to generate the determined torque (415).

The electro mechanical brake controller 130 may limit the speed of the motor 152 so that the speed does not exceed a predetermined maximum speed when controlling the motor 152 (417).

According to the embodiment of FIG. 4 described above, when a quick response is required based on the execution of the anti-lock braking system mode based on the vehicle 1, appropriate braking force of the brake system 100 is secured, so that the braking distance may be shortened.

For example, the second torque may be applied to the motor 152 at an initial rise point and an initial reduction point of the target braking pressure according to the execution of the anti-lock braking system mode, and the second torque applied to the motor 152 may be reduced while the target braking pressure is maintained within a predetermined minimum range. Accordingly, a pressure-boosting cycle and a pressure-reduction cycle of the brake system 100 may be shortened, and this may also be advantageously applied to the pitch control of the vehicle 1.

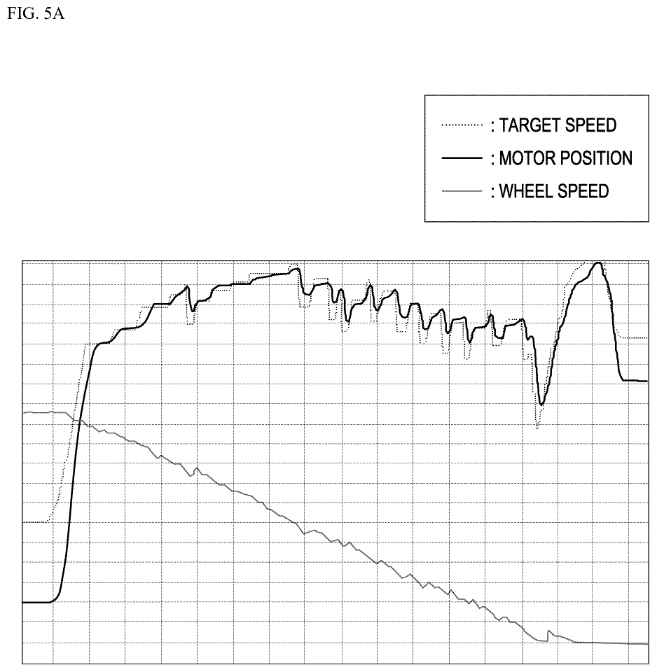

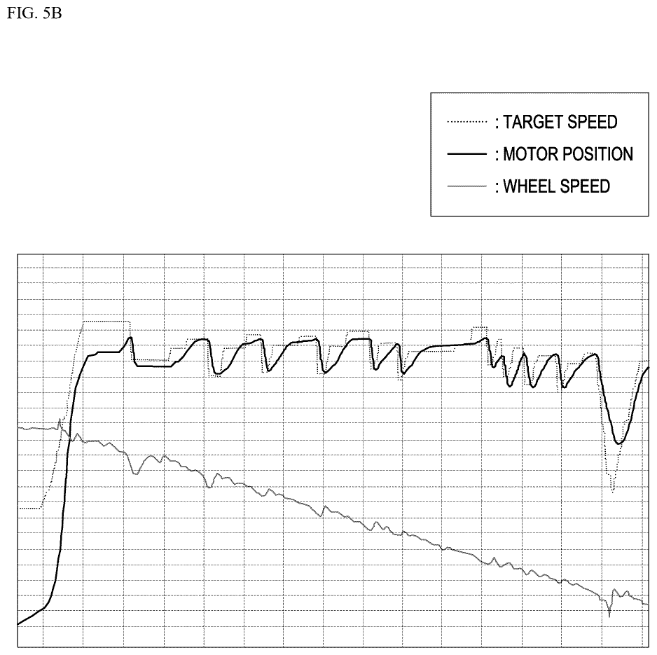

According to the embodiment of FIG. 4 described above, the relationship between the target speed, the motor position, and the wheel speed of the corresponding wheel may be as illustrated in FIGS. 5A and 5B.

FIGS. 5A and 5B are graphs illustrating the relationship between the target speed, motor position, and wheel speed when the anti-lock braking system mode of the brake system 100 is executed according to one embodiment.

Referring to FIGS. 5A and 5B, when comparing the target speed and the motor position of the motor 152, it can be seen that the motor 152 operates quickly and accurately to correspond to the target speed, and it can be confirmed that the wheel speed decreases according to the control of the motor 152 according to the execution of the anti-lock braking system mode.

Accordingly, it can be seen that the motor 152 of the electro mechanical brake 150 controlled according to the above-described embodiment improves the response performance of the motor 152 compared to the related art by moving the motor position similarly to the target speed.

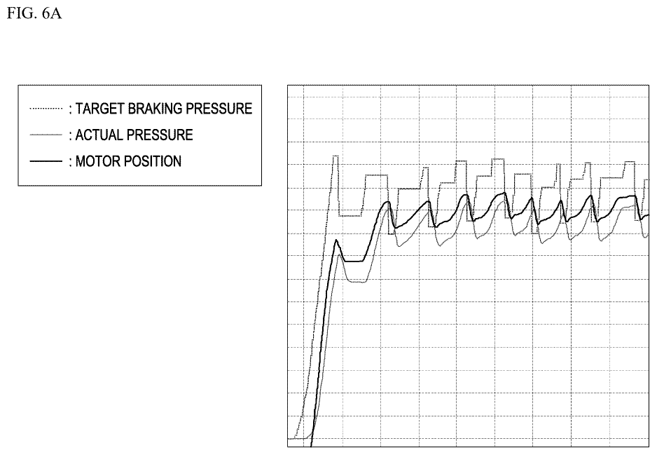

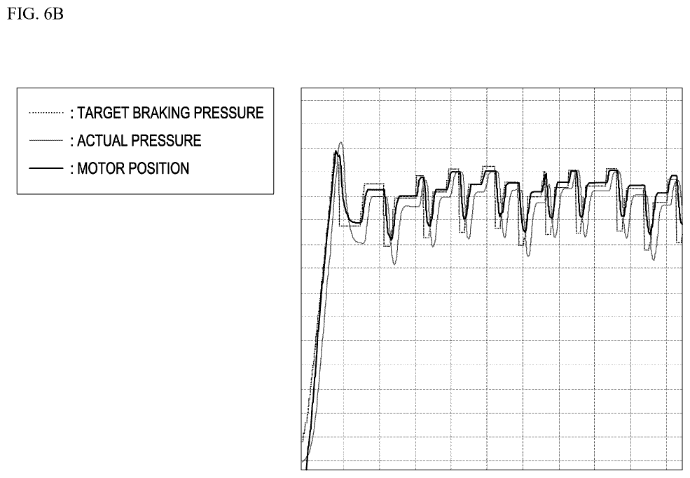

FIGS. 6A and 6B are graphs illustrating an actual pressure of an electro mechanical brake and a position of a motor of the electro mechanical brake according to a target braking pressure in a state of conventional pressure-boosting and pressure-reducing performance not improved and a state of pressure-boosting and pressure-reducing performance improved according to the above-described embodiment in the execution of the anti-lock braking system mode.

FIG. 6A is a graph illustrating the actual pressure of the electro mechanical brake and the position of the motor of the electro mechanical brake controlled according to the target braking pressure based on the execution of the anti-lock braking system mode in the state of conventional pressure-boosting and pressure-reduction performance not being improved.

FIG. 6B is a graph illustrating the actual pressure of the electro mechanical brake and the position of the motor of the electro mechanical brake controlled according to the target braking pressure based on the execution of the anti-lock braking system mode in the state of the pressure-boosting and pressure-reduction being improved according to the embodiments described above.

Referring to FIG. 6A, it can be seen that the actual pressure of the electro mechanical brake and the position of the motor of the electro mechanical brake controlled according to the related art are significantly different from the target braking pressure.

On the other hand, referring to FIG. 6B, it can be seen that the actual pressure of the electro mechanical brake and the position of the motor of the electro mechanical brake controlled according to the above-described embodiments are similar to the target braking pressure.

That is, when comparing FIGS. 6A and 6B, it can be seen that the control of the electro mechanical brake according to the above-described embodiments has improved pressure-boosting and pressure-reduction performance compared to the conventional one.

Meanwhile, in the above-described embodiments, the control of the electro mechanical brake 150 based on the execution of the anti-lock braking system mode of the brake system 100 has been described as an example, but it can be applied to all control modes that require pressure-boosting and pressure-reduction controllers of the electro mechanical brake, for example, control modes that require fine adjustment of braking pressure, such as electronic stability control (ESC) and/or traction control system (TCS) mode.

The brake system 100 and control method thereof according to the above-described embodiments may provide a technology for securing braking performance equivalent to or superior to that of the conventional hydraulic brake system.

For example, the brake system 100 and control method thereof may prevent shaking of the vehicle 1 corresponding to yaw and pitch while ensuring a braking distance from a target by stably stopping the vehicle 1 when an emergency braking of the vehicle 1 occurs or when the anti-lock braking system mode is executed. Accordingly, the braking feel of the vehicle 1 and the safety of the driver of the vehicle 1 may be improved.

Meanwhile, the disclosed embodiments may be implemented in the form of a recording medium that stores instructions executable by a computer. The instructions may be stored in the form of program codes, and when executed by a processor, can generate a program module to perform the operations of the disclosed embodiments. The recording medium may be implemented as a computer-readable recording medium.

Computer-readable recording media include all types of recording media that store instructions that can be deciphered by a computer. Examples include read only memory (ROM), random access memory (RAM), magnetic tape, magnetic disk, flash memory, and optical data storage devices.

A storage medium that can be read by the device may be provided in the form of a non-transitory storage medium. Here, “non-transitory” means only that the storage medium is a tangible device and does not contain signals (for example, electromagnetic waves), and this term does not distinguish between cases where data is stored semi-permanently in the storage medium and cases where data is stored temporarily. For example, a “non-transitory storage medium” may include a buffer in which data is temporarily stored.

The disclosed embodiments have been described with reference to the attached drawings as described above. Those skilled in the art will understand that the present disclosure can be implemented in forms other than the disclosed embodiments without changing the technical idea or essential features of the present disclosure. The disclosed embodiments are exemplary and should not be construed as limiting.

What is claimed is:

1. A brake system comprising:
an electro mechanical brake including a motor and configured to brake a wheel of a vehicle using the motor; and
an electro mechanical brake controller configured to control the motor,
wherein the electro mechanical brake controller is configured to:
determine a target speed for controlling the motor based on a target braking pressure, wherein the target speed for controlling the motor changes in proportion to a rate of change of the target braking pressure;
control the motor based on the target speed for controlling the motor;
feedback-control the motor based on a current speed of the motor and the target speed for controlling the motor; and
control the motor to generate a torque of the motor determined by adding a first torque of the motor controlled based on the target speed for controlling the motor and a second torque of the motor feedback-controlled based on the current speed of the motor and the target speed for controlling the motor.

2. The brake system according to claim 1, wherein the electro mechanical brake controller is configured to apply the second torque, feedback-controlled based on the current speed of the motor and the target speed for controlling the motor, to the motor at an initial rise point of the target braking pressure.

3. The brake system according to claim 2, wherein the electro mechanical brake controller is configured to reduce the second torque applied to the motor while maintaining the target braking pressure within a predetermined minimum range.

4. The brake system according to claim 1, wherein the electro mechanical brake controller is configured to apply the second torque applied to the motor at an initial reduction point of the target braking pressure.

5. The brake system according to claim 1, further comprising a controller configured to perform an anti-lock braking control in response to slip of the wheel of the vehicle and determine the target braking pressure based on the anti-lock braking control to transmit the determined target braking pressure to the electro mechanical brake controller.

6. The brake system according to claim 1, wherein the electro mechanical brake controller is configured to determine the target speed for controlling the motor based on a difference between the target braking pressure and a current braking pressure of the electro mechanical brake.

7. The brake system according to claim 1, wherein the electro mechanical brake controller is configured to determine the target speed for controlling the motor by multiplying a difference between the target braking pressure and a current braking pressure of the electro mechanical brake by a predetermined gain value.

8. The brake system according to claim 6, wherein the electro mechanical brake controller is configured to determine the target speed for controlling the motor corresponding the difference between the target braking pressure and the current braking pressure of the electro mechanical brake using predetermined mapping of a plurality of target speeds to a plurality of differences.

9. The brake system according to claim 1, wherein the electro mechanical brake controller is configured to control a speed of the motor not to exceed a predetermined maximum speed.

10. The brake system according to claim 1, wherein the electro mechanical brake controller is configured to feedback-control the motor so that the current speed of the motor follows the target speed for controlling the motor through proportional integral derivative (PID) control.

11. A method for controlling a brake system, the method comprising:
determining a target speed for controlling a motor of an electro mechanical brake based on a target braking pressure, wherein the target speed for controlling the motor changes in proportion to a rate of change of the target braking pressure;
controlling the motor based on the target speed for controlling the motor;
feedback-controlling the motor based on a current speed of the motor and the target speed for controlling the motor; and
controlling the motor to generate a torque of the motor determined by adding a first torque of the motor controlled based on the target speed for controlling the motor and a second torque of the motor feedback-controlled based on the current speed of the motor and the target speed for controlling the motor.

12. The method according to claim 11, wherein the second torque feedback-controlled based on the current speed of the motor and the target speed for controlling the motor is applied to the motor at an initial rise point of the target braking pressure.

13. The method according to claim 11, wherein the second torque applied to the motor is reduced while the target braking pressure is maintained within a predetermined minimum range.

14. The method according to claim 11, wherein the second torque applied to the motor is applied at an initial reduction point of the target braking pressure.

15. The method according to claim 11, wherein the target braking pressure is determined based on anti-lock braking control in response to slip of the wheel of the vehicle.

16. The method according to claim 11, wherein the determining of the target speed for controlling the motor includes determining the target speed for controlling the motor based on a difference between the target braking pressure and a current braking pressure of the electro mechanical brake.

17. The method according to claim 11, wherein the determining of the target speed for controlling the motor includes determining the target speed for controlling the motor by multiplying a difference between the target braking pressure and a current braking pressure of the electro mechanical brake by a predetermined gain value.

18. The method according to claim 16, wherein the determining of the target speed for controlling the motor includes determining the target speed for controlling the motor corresponding the difference between the target braking pressure and the current braking pressure of the electro mechanical brake using predetermined mapping of a plurality of target speeds to a plurality of differences.

19. The method according to claim 11, further comprising controlling a speed of the motor not to exceed a predetermined maximum speed.

20. The method according to claim 11, wherein the feedback-controlling of the motor includes feedback-controlling the motor so that the current speed of the motor follows the target speed for controlling the motor through proportional integral derivative (PID) control.
